(19) United States
(12) Patent Application Publication
(10) Pub. No.: US 2026/0298638 A1
(43) Pub. Date: Oct. 1, 2026

(54) SYSTEM FOR GRAVITY MAP AIDED NAVIGATION

(71) Applicant: The Charles Stark Draper Laboratory, Inc., Cambridge, MA (US)

(72) Inventors: Aneesa Spielvogel, Cambridge, MA (US); Andrew Spielvogel, Amherst, MA (US); Richard Stoner, Framingham, MA (US); Matthew Weinstein, Revere, MA (US)

(73) Assignee: The Charles Stark Draper Laboratory, Inc., Cambridge, MA (US)

(21) Appl. No.: 19/489,886

(22) PCT Filed: Jun. 6, 2024
(86) PCT No.: PCT/US2024/032851

§ 371 Date: Dec. 3, 2025

Related U.S. Application Data
(60) Provisional application No. 63/472,010, filed on Jun. 9, 2023.

(51) Int. Cl. G01C 21/16

(52) U.S. Cl. CPC G01C 21/185

(57) ABSTRACT

Gravity map based navigation is provided. A system can include a data processing system including one or more processors, coupled with memory. The data processing system can retrieve, based on an estimated position of the system, a value of gravity from values of gravity mapped to positions. The data processing system can determine an altitude of the system based on at least the value of gravity and a force measured by an accelerometer of the system. The data processing system can compare the altitude with a reference altitude to determine an altitude error measurement. The data processing system can determine a lateral position of the system based on the altitude error measurement.

### CROSS-REFERENCE TO RELATED APPLICATION

This application is a U.S. National Phase of International Patent Application No. PCT/US2024/032851, filed on Jun. 6, 2024, titled “SYSTEM FOR GRAVITY MAP AIDED NAVIGATION,” which claims the benefit of priority under 35 U.S.C. § 119 to U.S. Provisional Patent Application No. 63/472,010, filed on Jun. 9, 2023, the entire contents of which are hereby incorporated herein by referenced in its entirety for all purposes.

### GOVERNMENT CONTRACT

This invention was made with Government support under Contract No. N00014-20-c-1015 awarded by the Department of Defense. The Government has certain rights in this invention.

### BACKGROUND

An inertial navigation system (INS) can allow a platform, vehicle, or person to navigate based on measurements of motion and rotation sensors.

### SUMMARY

Technical solutions disclosed herein can include a system for gravity map aided navigation. The system can include an inertial measurement unit (IMU) including at least one 3-axis accelerometer and at least one 3-axis gyroscope. The system can include a data processing system including one or more processors, coupled with memory, to retrieve, based on an estimated position of the system, a value of gravity from values of gravity mapped to positions. The data processing system can store a map on the memory, the map or model storing the values of gravity mapped to the positions. The data processing system can retrieve, based on the estimated position, the value of gravity from the map or model. The map or model can be a gravity model, such as an EGM2008 model or a gridded map, such as the Smith and Sandwell map or any other type of gravity model or gridded product. The data processing system can determine an altitude of the system based on at least the value of gravity and a force measured by an IMU of the system. The system can compare the estimated altitude to a reference or measured altitude. This reference altitude can be sea level. The measured altitude can be based on a depth measurement of a sensor. The data processing system can compare the estimated altitude with the reference or measured altitude to determine an altitude error measurement. The data processing system can determine a lateral position of the system based on the altitude error measurement. The data processing system can perform inertial navigation to determine positions of the system over time with the altitude error measurement. Inertial navigation with the altitude error measurement can bound an error of the inertial navigation over time. The navigation bounding can occur because of the difference between the INS's current altitude estimate and an altitude measurement. This altitude error measurement can allow for the lateral navigation error to be observable.

At least one aspect is directed to a system. The system can include a data processing system including one or more processors, coupled with memory, to retrieve, based on an estimated position of the system, a value of gravity from a plurality of values of gravity mapped to a plurality of positions. The one or more processors can determine an altitude of the system based on at least the value of gravity and a force measured by an IMU of the system. The one or more processors can compare the altitude with a reference or measured altitude to determine an altitude error. The one or more processors can determine a lateral position of the system based on the altitude error.

The data processing system can perform inertial navigation to determine positions of the system over time with the altitude error, wherein the inertial navigation with the altitude error bounds an error of the inertial navigation over time.

The data processing system can store a map (or a model) on the memory, the map storing the plurality of values of gravity mapped to the plurality of positions. The data processing system can retrieve, based on the estimated position, the value of gravity from the map.

The data processing system can retrieve the value of gravity based on a predicted latitude and a predicted longitude of the system. The data processing system can retrieve the value of gravity based on all three of latitude, longitude, and altitude.

The data processing system can execute at least one navigation function that compensates for local gravity at the estimated position of the system with the value of gravity.

The data processing system can execute at least one navigation function that compensates for local gravity at the estimated position of the system through a subtraction with the value of gravity. The data processing system can determine an error in the lateral position based on the altitude error measurement, wherein the altitude error measurement indicates an error in the subtraction caused by the error in the lateral position.

The data processing system can retrieve the reference altitude from the memory, wherein the reference altitude is a predetermined level stored by the memory. The data processing system can compare the altitude with the reference altitude responsive to a retrieval of the reference altitude from the memory.

The data processing system can retrieve the reference altitude from the memory, wherein the reference altitude is a predetermined sea level of a ship stored by the memory. The data processing system can compare the altitude with the reference altitude responsive to a retrieval of the reference altitude from the memory.

The data processing system can receive a measurement of pressure from a pressure sensor of a submerged vehicle. The data processing system can determine the reference altitude based on the measurement of pressure.

The data processing system can receive a measurement from an altitude sensor. The data processing system can determine the reference altitude based on the measurement of the altitude sensor.

The data processing system can receive an angular velocity from a gyroscope. The data processing system can determine the estimated position based on a specific force of the accelerometer and the angular velocity. The data processing system can retrieve the value of gravity from the values of gravity mapped responsive to a determination of the estimated position.

The data processing system can execute a Kalman filter to output the lateral position based at least in part on the altitude error measurement. The data processing system can execute filter-based or optimization-based estimation methods (e.g., Kalman filtering, factor graph, etc.) to output the lateral position.

In various implementations, the accelerometer can be gimbaled.

The data processing system can use the value of gravity that represents a local gravity in an acceleration integration. The data processing system can retrieve a first gravity anomaly partial derivative (or a full gravity vector instead of a gravity anomaly) with respect to a north position from a first plurality of values mapped to the plurality of positions. The data processing system can retrieve a second gravity anomaly partial derivative (or a full gravity vector instead of a gravity anomaly) with respect to an east position from a second plurality of values mapped to the plurality of positions. The data processing system can use the first gravity anomaly partial derivative and the second gravity anomaly partial derivative in propagation of an error state of a filter. The data processing system can use a vertical deflection map in order to resolve a full gravity vector (e.g., a 3-axis gravity vector). The data processing system can, when using a gravity anomaly, a reference ellipsoid gravity model (e.g., WGS84) as a gravity anomaly is a disturbance from the nominal ellipsoid value.

At least one aspect is directed to a method. The method can include receiving, by a data processing system, coupled with memory, measurements from an angular rate sensor, such as a gyroscope, and measurements from an accelerometer. The method can include calculating, by the data processing system, altitude with the measurements of the angular rate sensor and the accelerometer. The method can include retrieving, by the data processing system, based on an estimated position of the data processing system, a value of gravity from values of gravity mapped to positions. The method can include determining, by the data processing system, an altitude of the data processing system based on at least the value of gravity and a force measured by an accelerometer of the data processing system. The method can include comparing, by the data processing system, the altitude with a reference altitude to determine an altitude error measurement. The method can include determining, by the data processing system, a lateral position of the data processing system based on the altitude error measurement.

The method can include performing, by the data processing, inertial navigation to determine positions of the data processing system over time with the altitude error measurement, wherein the inertial navigation with the altitude error measurement bounds an error of the inertial navigation over time.

The method can include executing, by the data processing, at least one navigation function that compensates for local gravity at the estimated position of the data processing system through a subtraction with the value of gravity. The method can include determining, by the data processing, an error in the lateral position based on the altitude error measurement, wherein the altitude error measurement indicates an error in the subtraction caused by the error in the lateral position.

At least one aspect is directed to an inertial navigation system. The inertial navigation system can include an accelerometer to measure a specific force. The inertial navigation system can include a gyroscope to measure a rotational velocity. The inertial navigation system can include processing circuitry. The processing circuitry can retrieve, based on an estimated position of a platform including the inertial navigation system, a value of gravity from values of gravity mapped to positions. The processing circuitry can determine an altitude of the platform based on at least the value of gravity, the specific force, and the rotational velocity. The processing circuitry can compare the altitude with a reference altitude to determine an altitude error measurement. The processing circuitry can determine a lateral position of the platform based on the altitude error measurement.

The processing circuitry can perform inertial navigation to determine positions of the platform over time with the altitude error measurement, wherein the inertial navigation with the altitude error measurement bounds an error of the inertial navigation over time.

The processing circuitry can execute at least one navigation function that compensates for local gravity at the estimated position of the platform through a subtraction with the value of gravity. The data processing system can determine an error in the lateral position based on the altitude error measurements, wherein the altitude error measurements provide a map matching comparison to the gravity map via the second integral of the vertical position. INS lateral position error can result in an error in the computed gravity, which can result in an error in the INS's computed altitude acceleration. This error integrates into an altitude error that can be measured by comparing the INS altitude estimate with an altitude reference to provide observability into the lateral position error.

The processing circuitry can execute at least one navigation function that compensates for local gravity at the estimated position of the platform through a subtraction with the value of gravity. The processing circuitry can determine an error in the lateral position based on the altitude error, wherein the altitude error indicates an error in the subtraction caused by the error in the lateral position.

The INS can include a gravimeter to measure a specific force. The processing circuitry can compensate for a bias and scale factor of the accelerometer with the specific force measured by the gravimeter.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an example system that determines position based on a gravity model.

FIG. 2 is an example system that determines position based on a gravity model and a gravimeter.

FIG. 3 indicates example gravity anomaly partial derivatives for north position and east position.

FIG. 4 is an example method of determining position based on a gravity model.

FIG. 5 is an example computing architecture of a data processing system that can implement the systems and methods discussed herein.

### DETAILED DESCRIPTION

Following below are more detailed descriptions of various concepts related to, and implementations of, methods, apparatuses, and systems of gravity map aided navigation. The various concepts introduced above and discussed in greater detail below may be implemented in any of numerous ways.

A navigation system of a platform (e.g., a vehicle, device, or person) can utilize a global positioning system (GPS) to navigate based on communication with satellites. However, if satellite communication is unavailable (e.g., a GPS denied scenario), the vehicle may not be able to navigate based on the GPS. GPS may not be available if satellite communication is jammed, satellites are malfunctioning, the platform's GPS receivers are malfunctioning, a location does not have satellite access, the platform is underwater, etc. Therefore, the platform can navigate based on an INS. The INS can be unaided, in that it has no other known reference data. For example, an INS can include inertial measurement units (IMUs), such as accelerometers that measure motion of the platform and gyroscopes that measure rotation of the platform. Therefore, the vehicle can continue navigating even when there is no GPS access. However, the INS can have unbounded error. Errors in position, orientation, and velocity determined by the INS can compound and grow over time. Therefore, an INS can intrinsically lack the capability to provide reliable position, velocity, or orientation information for an indefinite term.

A system can bound the error of the INS through directly comparing specific force to gravity map data. Gravimetry aided navigation can use changes in the earth's gravity field changes as a function of latitude and longitude. Given a highly accurate observation of instantaneous gravity, together with a gravity map, a system can compare the measured quantity to the expected quantity (as a function of estimated position), in order to bound position to be along a contour of constant gravity. However, sensors may be unable to identically measure the magnitude of local gravity as distinguished from inertial input. Instead, gravimeters can measure specific force; inertial acceleration minus mass attraction gravitation. A measurement of specific force in the identically vertical direction, fᵥ, can be related to vertical gravity by

$${f}_{v} = \ddot{h} - 2 {Ω}_{E a r t h} cos ( Φ ) {v}_{e} - \frac{{v}_{n}^{2} + {v}_{e}^{2}}{{R}_{Earth}} - {g}_{v} ( Φ , λ ) , \qquad Function 1$$

where \ddot{h} is altitude acceleration,

$$2 {Ω}_{E a r t h} cos ( Φ ) {v}_{e} + \frac{{v}_{n}^{2} + {v}_{e}^{2}}{{R}_{E a r t h}}$$

is the change in centrifugal acceleration due to lateral velocity (the Eötvös effect), and gᵥ(Φ,λ) is vertical gravity at the current latitude, Φ, and longitude, λ. Given such a measurement, a system can compare the measured quantity to an expected quantity using navigated velocity, a gravity map to compute gᵥ as a function of position, and an estimate of \ddot{h}. Such an approach, however, has at least two technical problems or challenges. First, the approach may need an estimate of \ddot{h} which may not be readily available as a navigation quantity (requires finite-differencing or assuming zero over long enough averaging periods). Second, the approach may need a measurement of specific force in the vertical direction and thus is not directly applicable to the case where a gravimeter is non-gimbaled (e.g., a strapdown INS implementation).

To solve for these and other technical issues, this technical solution can utilize an additional signal of known location dependence as an additional correlate in order to constrain the errors in the INS and bound the errors such that the INS can be reliable for a long or indefinite period of time. For example, gravity can be utilized as a signal in the INS. The INS can utilize gravity values or measurements of a gravity map to constrain the error of the INS. Gravity maps or models can include high accuracy gravity measurements of Earth or Earth's oceans. Measurements of gravity, combined with reference to a gravity map, can reveal inertial navigation inaccuracy by reporting a discrepancy between measured gravity and the value of gravity reported by a gravity map at the purported location of the platform.

The present solution can utilize knowledge of the vertical position or altitude of the platform to compare measured gravitational signals with nominal gravity map values. For example, for a platform such as a ship that travels along the surface of the ocean, the altitude of the platform can be known. For example, for a platform such as a submarine or submerged vehicle, measurements of a pressure sensor can be used to determine or identify depth. Rather than directly comparing specific force measurements of an accelerometer of the INS to data of the gravity map, the present solution can use the map to do gravity compensation of the measured specific force, and then compare the second integral of the compensated specific force to the reference altitude.

For example, the present solution can use a predicted, asserted, or identified location of the platform based on accelerometer or gyroscope measurements of the INS. With this predicted location, the INS can retrieve a value of gravity from a gravity map at the predicted location. With the retrieved value of gravity, the INS can subtract out, or compensate for, local gravity at the location of the platform. However, because the INS predicted or estimated position has error, the retrieved value of gravity may not be the true local gravity, and therefore, the retrieved value may also have error. The altitude determined by the INS with this gravity value can be compared with the reference altitude to determine an altitude error measurement. This altitude error measurement can therefore be based at least in part on error in lateral position. This altitude error measurement can be used to determine the lateral position of the platform, and thus compensate for the error in lateral position. This can compensate for, and constrain, the lateral position error of the INS. This comparison can suppress the confounding effects of platform motion, as opposed to a direct comparison of specific data with the gravity map. For example, the error in altitude can be input into a Kalman filter (factor graph, or any other filtering technique) of the INS to prevent error in INS position divergence.

The INS of this technical solution may not need an estimate of altitude acceleration. Furthermore, the INS of this technical solution can be a strapdown implementation; the accelerometers or gyroscopes may not need to be gimbaled (e.g., mounted to a gimble apparatus). However, in other implementations, the system can be gimbaled. The INS described herein can detect errors in gravity magnitude by observing errors in navigated altitude (by comparing a calculated altitude to an altitude reference). The INS described herein can be applied to any type of platform. For example, a vehicle such as a boat or ship, airplane, drone, car, truck, tank, spaceship, submarine, submerged vehicle, helicopter, etc. can navigate based on the INS described herein. Furthermore, the solution described herein can be applied to commercial or military vehicles.

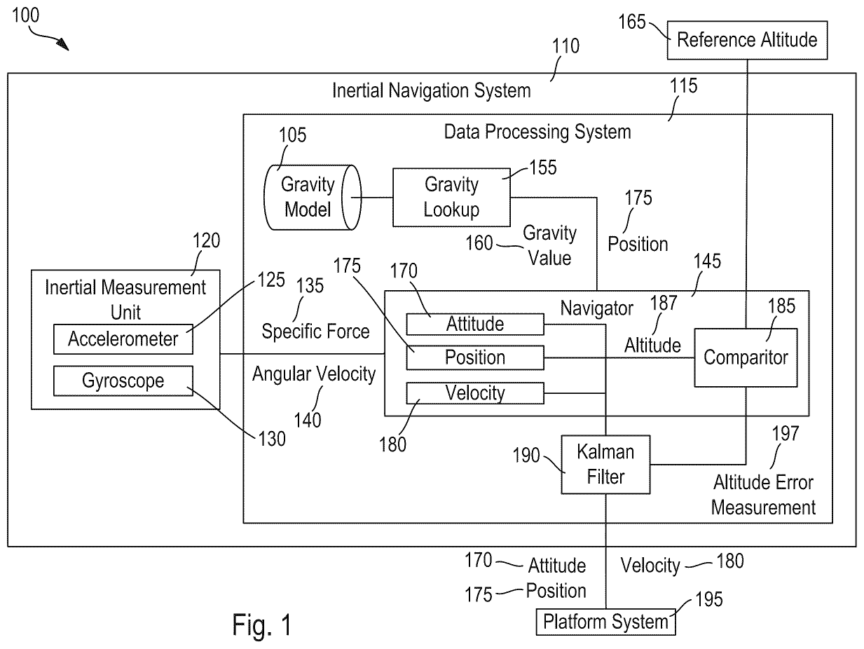

Referring now to FIG. 1, among others, an example system 100 that determines position based on at least one gravity model 105 is shown. The system 100 can be a device, apparatus, group, or collection of devices or apparatus. The system 100 can be a part of, or included in, a platform that moves, travels, accelerates, decelerates, changes direction, turns, or changes altitude. The platform can be a vehicle such as a boat, a ship, an airplane, a drone, a car, a truck, a tank, a spaceship, a submarine, a submerged vehicle, a helicopter, etc. Furthermore, the platform can be a commercial or military vehicle. The system 100 can include an INS 110. The INS 110 can be a system that determines an attitude 170, a position 175, and a velocity 180.

The INS 110 can include at least one IMU 120. The IMU 120 can include at least one sensor. The IMU 120 can include multiple sensors. The IMU 120 can collect measurements, signals, values, or data from the sensors. The IMU 120 can perform signal filtering, pre-processing, amplification, analog to digital conversion, or other operations. The IMU 120 can provide signals of the sensors to a data processing system 115 that are based on the measurements of the sensors of the IMU 120.

For example, the IMU 120 can include at least one accelerometer 125. The accelerometer 125 can be a single axis accelerometer or a multi-axis accelerometer (e.g., a 3-axis accelerometer). The IMU 120 may need a 3-axis accelerometer and a 3-axis gyroscope (or other angular rate sensor). The IMU 120 can include an optional sensor, such as an additional highly stable and accurate single axis accelerometer/gravimeter. The IMU 120 may need to be a navigation grade IMU (e.g., an IMU with an error of 0.01 degrees per hour or less, have high stability or extended durations of time, or be reliable in harsh environments). The accelerometer 125 can measure a specific force 135 in one or multiple axes. The accelerometer 125 can provide at least one specific force 135 to the data processing system 115. For example, the accelerometer 125 can provide a signal indicating specific force 135 in each axis to the data processing system 115. Furthermore, the IMU 120 can include at least one gyroscope 130. The gyroscope 130 can measure angular velocity 140. The gyroscope 130 can provide the angular velocity 140 to the data processing system 115. The gyroscope 130 can be a single axis gyroscope or a multi-axis gyroscope (e.g., a 3-axis gyroscope). For example, the gyroscope 130 can provide a signal indicating angular velocity 140 in each axis to the data processing system 115.

The INS 110 can include at least one data processing system 115. The data processing system 115 can be a computing system, a microprocessor, a microcontroller, an application specific integrated circuit, an analog circuit, a digital circuit, a system on a chip (SOC) or any other kind of circuit or collection of components that can perform navigation and process the specific force 135 and the angular velocity 140. The data processing system 115 can implement at least one software component, piece of code, script, module, function, or executable. The data processing system 115 can include logic gates, logic circuitry, processing circuitry, or hardware components. The data processing system 115 can include at least one navigator 145, gravity lookup 155, and Kalman filter 190 (e.g., or any other filtering or smoothing component), which can be instructions or code stored by a memory device of the data processing system 115 and executed by a processor of the data processing system 115. The navigator 145, the gravity lookup 155, and the Kalman filter 190 can be hardware components or circuits, or alternatively software components executed on processors.

The navigator 145 can be a component or piece of the system 110 that determines, generates, or computes an altitude error 197 for use by a Kalman filter 190, or other estimation algorithm, such as an optimization-based algorithm, to determine lateral position of the platform 100. The navigator 145 can receive the specific force 135 from the accelerometer 125 of the IMU 120. The navigator 145 can receive the angular velocity 140 from the gyroscope 130 of the IMU 120. The navigator 145 can execute one or multiple navigation equations, relations, functions, calculations, or computations to determine an attitude 170, a position 175, and a velocity 180 of the platform. The navigator 145 can perform inertial navigation with a starting known location. The known location can be a predefined location or a GPS indicated position. In some implementations, the known location can be transferred from another INS or other position system (e.g., acoustic positioning system, a radio frequency positioning system, an optical positioning system, etc.).

For example, the navigator 145 can determine the attitude 170 from the angular velocity 140. The attitude 170 can be maintained by sensor fusion of the accelerometer and gyroscope measurements. The accelerometer measurements may be needed to stop the attitude 170 from diverging. The navigator 145 can perform an integral on the angular velocity 140 to determine an attitude or orientation of the platform. For example, the attitude 170 can be a pitch, roll, or yaw of the platform. The attitude 170 can indicate a degree or angle value. The attitude 170 can indicate an orientation of the platform with respect to a particular direction, e.g., North, East, Down. The attitude 170 can be a rotation of the platform 100 with respect to another frame, such as Earth Centered Earth Fixed (ECEF), earth centered-inertial (ECI), north-east-down (NED), J2000, etc.

The navigator 145 can determine the position 175 and the velocity 180 from the specific force 135 and the angular velocity 140. For example, the navigator 145 can convert the specific force 135 into a navigation or inertial frame. In some implementations, the navigator 145 can navigate in a non-inertial frame, such as a geodetic frame, an ECEF frame, etc. The navigator 145 can convert the specific force 135 into the inertial frame based on the attitude 170. The navigator 145 can subtract out a gravity value, and then perform two integrals of the specific force 135 to determine the position 175 and the velocity 180. The position 175 of the platform can be a latitude, longitude, altitude, Northern position, Eastern position, ECEF position, ECI position, NED, etc. The velocity 180 can indicate a velocity of the platform in one or multiple directions, e.g., a Northern velocity, an Eastern velocity, a Down velocity, etc. The position and velocity can be in an inertial frame, such as ECI, J2000, etc. The INS 110 can navigate in the inertial frame, and then transform back into latitude, longitude, and altitude or other frames like ECEF, local NED, ECI, etc. The latitude, longitude, and altitude can be an output of the INS.

The navigator 145 can use a position 175 to lookup or retrieve a gravity value 160. For example, the INS navigated position 175 can be used by the gravity lookup 155 to lookup the gravity value 160 from the gravity model 105. For example, the navigator 145 can determine the attitude 170, the position 175, and the velocity 180 with or without the gravity value 160. The resulting position 175 can be a predicted position, or an estimate of the position of the platform. The gravity lookup 155 can query the gravity model 105 for the gravity value 160 at the position 175. However, because the position 175 may have an error, the retrieved gravity value 160 may also have error. For example, the retrieved gravity value 160 may not be the actual or true gravity value for the actual position of the platform.

The gravity model 105 can be a database, data structure, storage construct, set of memory locations, etc. that store gravity values 160 for one or multiple locations. The gravity model 105 can be a gravity map, a gridded map, or any other local gravity lookup. For example, the gravity model 105 can be a model, such as the EGM2008 spherical harmonics model. For example, the gravity model 105 can be a relational database management system (RDMS), a key-value database, a map, a graph database, or any other type of database. The gravity model 105 can relate, associate, or link multiple positions (e.g., longitudes, latitudes, or altitudes) with gravity values 160. For example, the gravity model 105 can map gravity across the surface of the Earth, across the surface of the ocean, through a variety of depths of the ocean, across land, under the Earth, etc.

With the retrieved gravity value 160, the navigator 145 can use the gravity value 160 to compensate for gravity in the calculation of the position 175 and the velocity 180. For example, the navigator 145 can subtract out the gravity value 160 from the specific force 135 to compensate for the effects of gravity. However, because the position 175 has lateral error, and the gravity value 160 retrieved may not be the true value of gravity at the actual location of the platform, the calculated position 175 and velocity 180 may have error.

An altitude 187 of the position 175 can be compared with a reference altitude input 165 to detect the error in altitude, and effectively perform a gravity map comparison. For example, the altitude 187 can have error based on the value of gravity 160 not being the true gravity value. The reference altitude 165 can represent a true altitude of the platform, and therefore, the true gravity at the position of the platform. A comparator 185 can compare the altitude 187 to the reference altitude 165 to determine an altitude error measurement 197. For example, the comparator 185 can subtract the altitude 187 from the reference altitude 165. Similarly, the comparator 185 can subtract the reference altitude 165 from the altitude 187. The altitude error measurement 197 can quantify the error in position 175. The data processing system 115 can use the altitude error measurement 197 to correct for, compensate for, or constrain error in the lateral position of the platform, e.g., in the position 175 and also constrain altitude, e.g., the vertical position of the platform 100. The reference altitude 165 can be an input to the data processing system 115 or a value stored within the data processing system 115. The reference altitude 165 can be or include a reference such as geoid, direct altitude measurements, or indirect altitude measurements through a sensor like a barometer.

The reference altitude 165 can be a predetermined value stored by a memory device of the data processing system 115. For example, if the platform is a ship, the reference altitude 165 can be a predetermined sea level or predetermined altitude of the INS 110 on the ship. The reference altitude 165 can be determined from measurements of altitude sensors of the INS 110 or sensors of the platform. For example, for a submerged vehicle or submarine, a pressure sensor can be used to measure depth. The data processing system 115 can determine a depth or altitude of the platform based on pressure measurements of the pressure sensor. In some implementations, the reference altitude 165 can be determined from an altimeter, such as an altimeter of an airplane, a helicopter, a drone, or any other airborne platform.

The Kalman filter 190 can execute based on the attitude 170, the position 175, the velocity 180, and the altitude error measurement 197. The Kalman filter 190 can execute on values of the attitude 170, the position 175, the velocity 180, and the altitude error measurement 197 over time, e.g., on a series of values, a timeseries of values, signals, etc. The Kalman filter 190 can receive the attitude 170, the position 175, the velocity 180, and the altitude error 197. Instead of a Kalman filter, the component 190 can be any type of smoothing, filtering, or optimization component, such as a factor graph. The Kalman filter 190 can output a filtered version of the attitude 170, the position 175, and the velocity 180. The altitude error 197 can be used by the Kalman filter 190 to correct for errors in the position 175, e.g., to correct for errors in the lateral position of the platform and/or vertical position error.

In some implementations, high rate navigation determinations (e.g., position 175, attitude 170, or velocity 180 of the platform 100) of the navigator 145 is output to the platform 100 for navigating, guiding, controlling, or operating the platform 100. The navigator 145 can implement a high rate navigation loop for control and guidance, while the output of the Kalman filter 190, which can run at a lower rate, can be used to update (e.g., constrain, correct, or reduce error in) the high rate loop of the navigator. In some implementations, an output of the Kalman filter 190 can be provided to a platform system 195 for navigation of the platform. The attitude 170, the position 175, and or the velocity 180 can be provided (by the navigator 145 at a high rate or by the Kalman filter at a lower rate) to at least one platform system 195. The platform system 195 can be a system of a platform, such as a vehicle. The platform system 195 can include display screens or user interfaces to display the attitude 170, the position 175, or the velocity 180 to a user, such as a helmsman, a pilot, a co-pilot, a captain, an analyst, or any other user. The platform system 195 can execute an autopilot, autonomous navigation, semi-autonomous navigation, etc. Based on the attitude 170, the position 175, or the velocity 180, the platform system 195 can control tractive components of a vehicle, such as engines, propellers, rudders, fins, motors, helicopter blades, jet engines, etc. The platform 195 can use the attitude 170, the position 175, or the velocity 180 to drive the vehicle, e.g., turn the vehicle, rotate the vehicle, accelerate, decelerate, hover, stop, stay in a single position, follow a trajectory, reach a destination, etc.

The difference between INS indicated altitude 187 and measured altitude 165 can provide an observable measurement, and can be equivalent to gravity based map-matching. For example, local gravity can be compensated for by the navigator 145 through looking up the gravity value 160 from the gravity model 105. Local gravity can be compensated for before the measurements of the accelerometer 125 are integrated. An error in INS indicated position 175 thus can result in an error in computed gravity, which in turn results in an error in computed altitude acceleration. The error in altitude acceleration, δ\ddot{h}, can be expressed in terms of navigation errors by re-ordering Function 1 and linearizing about truth to yield:

$$δ \ddot{h} \approx 2 {Ω}_{E a r t h} cos ( Φ ) δ {v}_{e} + δ {g}_{v} ( δ {r}_{n} , δ {r}_{e} , δ h ) + δ Δ {g}_{m a p} + δ {f}_{v} , \qquad Function 2$$

$$δ {g}_{v} \approx \frac{\partial {g}_{v}}{\partial {r}_{n}} δ {r}_{n} + \frac{\partial {g}_{v}}{\partial {r}_{e}} δ {r}_{e} + \frac{2 g}{R} δ h ,$$

$$\frac{δ {g}_{v}}{δ {r}_{n}} = \frac{\partial {g}_{WGS 84}}{\partial {r}_{n}} + \frac{\partial Δ g}{\partial {r}_{n}} , \frac{δ {g}_{v}}{δ {r}_{e}} = \frac{\partial Δ g}{\partial {r}_{e}} ,$$

where δvₑ, δrₙ, δrₑ, δh, δΔgₘₐₚ, and δfᵥ denote errors in: east velocity, north position, east position, altitude, gravity anomaly reference map, and vertical accelerometer output, respectively. The

$$\frac{2 g}{R}$$

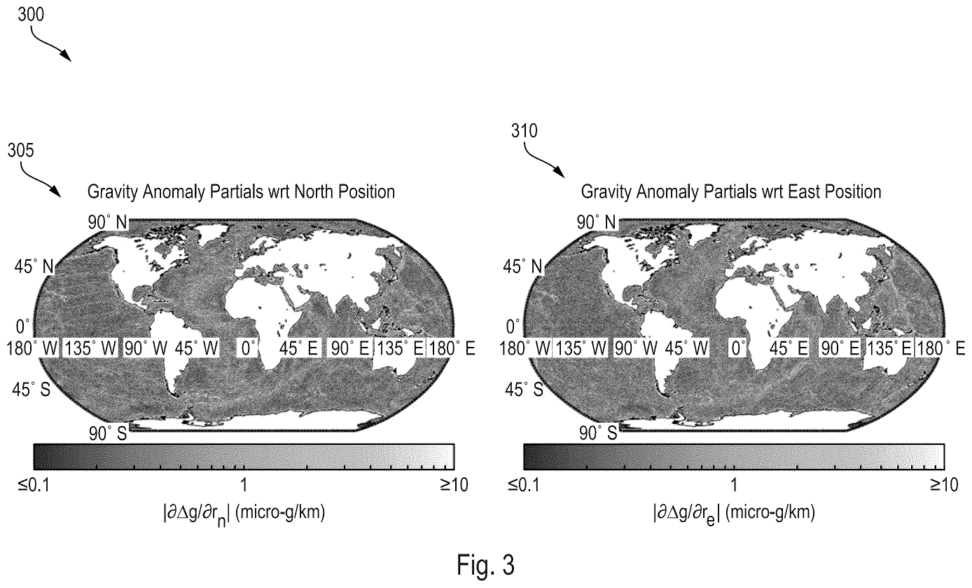

term can represent instability of the vertical channel (which necessitates an altitude reference for terrestrial inertial navigators) and the terms ∂gᵥ/∂rₙ and ∂gᵥ/∂rₑ quantify the error in computed vertical gravity due to errors in north and east position, respectively. As shown in FIG. 3, the sensitivities of vertical gravity to lateral position errors can typically be small relative to vertical accelerometer errors, δfᵥ.

In view of the formulation of Function 2, errors in east velocity and level position can result in errors in navigated altitude through the double integral of Function 2. Gravity map-matching can then be performed by comparing navigated altitude 187 to an external altitude reference 165 (e.g. from a depth detector or reference if operating on the ocean's surface). In order to extract valuable information from such a measurement, however, the vertical accelerometer error may be small.

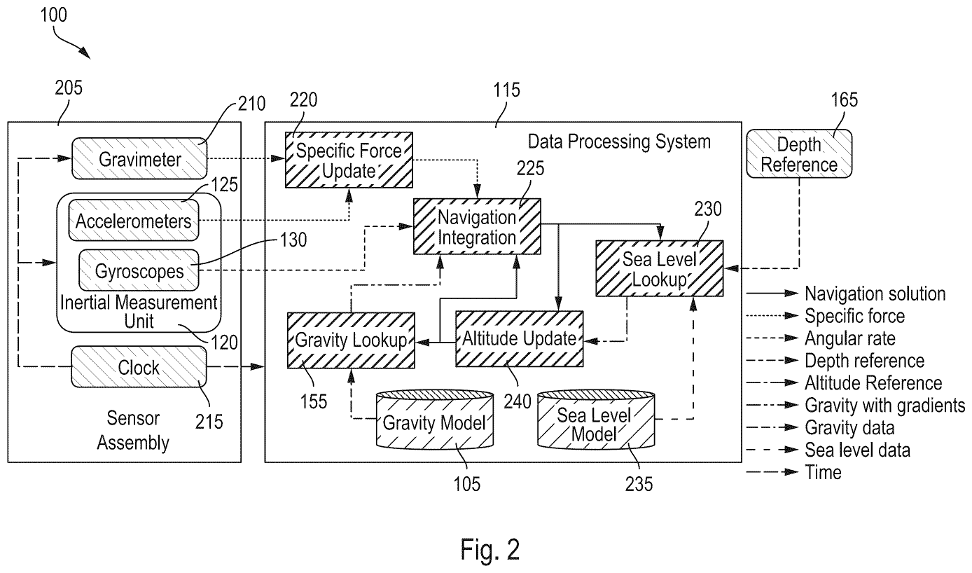

Referring now to FIG. 2, among others, an example system 100 that determines position based on the gravity model 105 and a gravimeter 210 is shown. The system 100 can include at least one sensor assembly 205. The sensor assembly 205 can include at least one gravimeter 210, at least one IMU 120, and at least one clock 215. The sensor assembly 205 can couple or connect with the data processing system 115. The gravimeter 210 can be a quantum gravimeter. The gravimeter 210 can be a single axis or multi-axis gravimeter. The gravimeter 210 can be an optional component of the system 100. The gravimeter 210 can be a single axis or multi-axis accelerometer with very low bias draft. The single axis accelerometer can be closely aligned to a vertical axis to provide long term bias stability in the vertical channel used for calculating altitude. The clock 215 can generate a signal, such as a pulse wave. The clock 215 can provide the signal of the gravimeter 210, the IMU 120, and the data processing system 115. The gravimeter 210, the IMU 120, and the data processing system 115 can operate based on the time signal of the clock 215. In this regard, the gravimeter 210, the IMU 120, and the data processing system 115 can be synchronized as they operate based on the same time signal of the clock 215.

The data processing system 115 can include a specific force update 220. The specific force update 220 can be an optional component of the system 100. For example, the data processing system 115 may only include a specific force update 220 if the sensor assembly 205 includes the gravimeter 210. The specific force update 220 can compensate for bias and scale factors of the accelerometer 125 with measurements of the gravimeter 210 (e.g., specific force measurements of the gravimeter 210). The data processing system 115 can include a navigation integration 225. The navigation integration 225 can perform inertial navigation. For example, the navigation integration 225 can perform inertial navigation by integrating IMU 120 outputs from the accelerometers 125 and gyroscopes 130. The navigation integration 225 can navigate based on the specific force 135 received from the accelerometers 125, or from the specific force update 220, and further based on the angular rate 140 received from the gyroscopes 130. The navigation integration 225 can determine the attitude 170, the position 175, or the velocity 180. The navigation integration 225 can compensate for the IMU 120 based on IMU parameter estimates from the Kalman filter 190.

The gravity lookup 155 can retrieve gravity data from the gravity model 105 based on an estimated position 175 of the platform. The gravity lookup 155 can provide a local gravity value and gravity gradients to the navigation integration 225. The data processing system 115 can include a sea level model 235. The sea level model 235 can indicate a sea level for multiple locations or positions on Earth. The sea level lookup 230 can retrieve a sea level from the sea level model 235 based on an estimated position 175 of the platform. The sea level looked-up by the sea level lookup 230 can be the altitude reference 165. The sea level lookup 230 can determine a sea level, depth, or altitude based on a reference, such as a depth reference 165 or other measurement received from an altitude sensor, a depth sensor, a pressure sensor, etc. The sea level lookup 230 can determine or compute a reference altitude 165 and provide the reference altitude 165 to the altitude update 240. The data processing system can include an altitude update 240. The altitude update 240 can compare the reference altitude 165 to the computed altitude of the navigation integration 225 to determine the altitude error measurement 197.

Referring now to FIG. 3, among others, gravity anomaly partial derivatives for north position and east position is shown. The chart 300 can include gravity anomaly partial derivatives with respect to the north position and with respect to east position. For example, the chart 300 can include a first chart 305 that represents values for gravity anomaly partial derivatives with respect to a north position. The chart 300 can include a second chart 310 that represents values for gravity anomaly partial derivatives with respect to an east position.

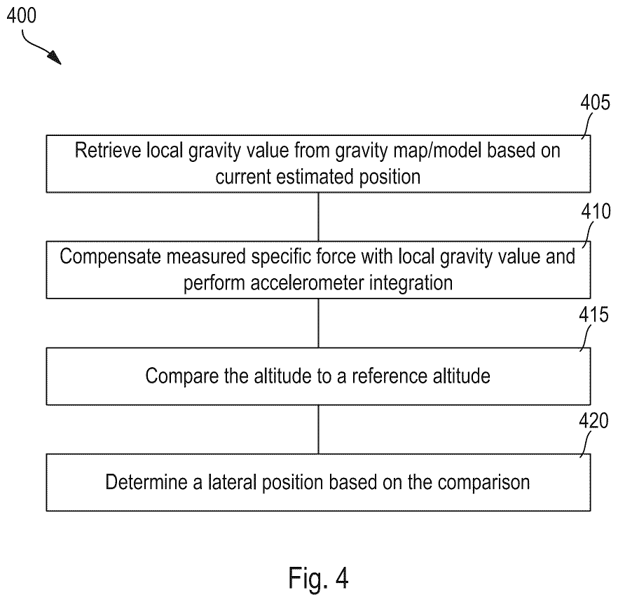

Referring now to FIG. 4, among others, an example method 400 of determining position based on a gravity map is shown. At least a portion of the method 400 can be performed by the INS 110, the data processing system 115, a computing system, a hardware circuit, an analog circuit, or any other electronic device, apparatus, or system. The method 400 can include an ACT 405 of retrieving a value of a gravity map. ACT 405 can include retrieving a value of local gravity from a gravity map. For example, ACT 405 can be or include retrieving a local gravity value from a gravity map/model based on current estimated position. The method 400 can include an ACT 410 of determining an altitude based on the value and a specific force. For example, ACT 410 can be or include compensating measured specific force with a local gravity value and performing accelerometer integration. The method 400 can include an ACT 415 of comparing the altitude to a reference altitude. The method 400 can include an ACT 420 of determining a lateral position based on the comparison.

At ACT 405, the method 400 can include retrieving, by the data processing system 115, the gravity value 160. For example, the data processing system 115 can predict a position of the platform, based on the specific force 135 measured by the accelerometer 125 and an angular velocity 140 measured by a gyroscope 130. The data processing system 115 can determine position in three degrees of freedom (DOF). The navigator 145 can execute at least one navigation function that can compute an attitude 170 of the platform with the angular velocity 140 through integrating the angular velocity 140. The navigator 145 can transform the specific force 135 into an inertial frame with the attitude 170. Then, the navigator 145 can compensate for gravity, and integrate the specific force 135 twice to determine position 175 and velocity 180. The INS estimated position 175 can be used to perform a gravity lookup from the gravity model 105, e.g., from a gravity map or model 105.

The data processing system 115 can retrieve or look up the gravity value 160 based on the position 175. For example, the gravity lookup 155 of the data processing system 115 can retrieve at least one gravity value 160 corresponding to local gravity at the location of the INS 110. The lookup can return partial derivative with respect to a North direction and a partial derivative with respect to an East direction. The gravity lookup can return the local gravity and/or the local gravity gradient, e.g., partial derivatives with respect to North and East.

At ACT 410, the method 400 can include determining, by the data processing system 115, an altitude 187 based on the value and a specific force. For example, the data processing system 115 can compensate for local gravity based on the gravity value 160 retrieved at ACT 405. For example, the data processing system 115 can compensate for local gravity by subtracting out the gravity value 160 in at least one navigation function. The data processing system 115 can subtract the gravity value 160 from the specific force 135 and perform integration on the resulting value to determine altitude.

At ACT 415, the method 400 can include comparing, by the data processing system 115, the altitude to a reference altitude. For example, the comparator 185 can compare the altitude 187 to the reference altitude 165. The reference altitude 165 can be a known or true altitude of the platform. For example, if the platform is a ship or travels along the surface of the ocean, the reference altitude 165 can be predefined and stored by a memory device of the INS 110. If the platform is a submarine or submerged vehicle, the INS 110 can include a pressure sensor that detects a pressure, and the reference altitude 165 can be determined by the data processing system 115 based on the measurements of the pressure sensor. Through comparing the altitude 187 and the reference altitude 165, an altitude error 197 can be determined. Because there is lateral error in the position 175, the gravity value 160 retrieved from the gravity model 105 may not represent the true gravity at the position of the platform. However, because the actual altitude of the platform is known through the reference altitude 165, the comparison of the altitude 187 to the reference altitude 165 can produce an altitude error 197, which can be a measurable error indicating error in the lateral position of the platform.

At ACT 420, the method 400 can include determining, by the data processing system 115, a lateral position based on the comparison. For example, based on the comparison of ACT 415, the data processing system 115 can determine the lateral position of the platform. For example, the data processing system 115 can provide the attitude 170, the position 175, and the velocity 180 to a Kalman filter 190 to filter the signals to reduce error in the signals. In some implementations, instead of, or in addition to, using a Kalman filter 190, the method 400 can include using any smoothing technique, filtering technique, or factor graph to reduce errors in the signals. Furthermore, the navigator 145 can provide the altitude error 197 to the Kalman filter 190. The Kalman filter 190 can execute with the altitude error 197 to reduce and constrain error in the lateral position determined by the navigator 145. An output of the Kalman filter 190 can be provided to the platform system 195 to for navigation of the platform.

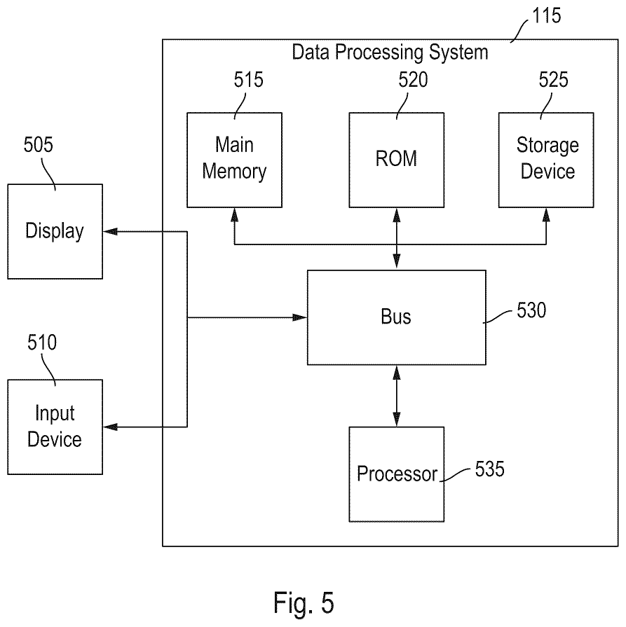

Referring now to FIG. 5, among others, an example computing architecture of the data processing system 115 that can implement the systems and methods discussed herein is shown. The data processing system 115 includes at least one bus 530 or other communication component for communicating information and at least one processor 535 or processing circuit coupled to the bus 530 for processing information. The data processing system 115 can also include one or more processors 535 or processing circuits coupled to the bus for processing information. The data processing system 115 can include at least one main memory 515, such as a random access memory (RAM) or other dynamic storage device, coupled to the bus 530 for storing information, and instructions to be executed by the processor 535. The main memory 515 can be used for storing information during execution of instructions by the processor 535. The data processing system 115 can further include at least one read only memory (ROM) 520 or other static storage device coupled to the bus 530 for storing static information and instructions for the processor 535. A storage device 525, such as a solid state device, magnetic disk or optical disk, can be coupled to the bus 530 to persistently store information and instructions.

The data processing system 115 may be coupled via the bus 530 to a display 505, such as a liquid crystal display, or active matrix display, for displaying information to a user such as a pilot, operator, navigator, sailor, or user. An input device 510, such as a keyboard or voice interface may be coupled to the bus 530 for communicating information and commands to the processor 535. The input device 510 can include a touch screen display 505. The input device 510 can also include a cursor control, such as a mouse, a trackball, or cursor direction keys, for communicating direction information and command selections to the processor 535 and for controlling cursor movement on the display 505.

The processes, systems and methods described herein can be implemented by the data processing system 115 in response to the processor 535 executing an arrangement of instructions contained in main memory 515. Such instructions can be read into main memory 515 from another computer-readable medium, such as the storage device 525. Execution of the arrangement of instructions contained in main memory 515 causes the data processing system 115 to perform the illustrative processes described herein. One or more processors in a multi-processing arrangement may also be employed to execute the instructions contained in main memory 515. Hard-wired circuitry can be used in place of or in combination with software instructions together with the systems and methods described herein. Systems and methods described herein are not limited to any specific combination of hardware circuitry and software.

Although an example computing system has been described in FIG. 5, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, Python, RUST, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method ACTS or system elements, those ACTS and those elements may be combined in other ways to accomplish the same objectives. ACTS, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. A system, comprising:
a data processing system comprising one or more processors, coupled with memory, to:
identify, based on an estimated position of the system, a value of gravity from a plurality of values of gravity mapped to a plurality of positions;
determine an altitude of the system based on the value of gravity and a force measured by an accelerometer of the system;
compare the altitude with a reference altitude to identify an altitude error; and
determine a position of the system based on the altitude error.

2. The system of claim 1, comprising the data processing system to:
perform inertial navigation to determine positions of the system over time with the altitude error, wherein the inertial navigation with the altitude error bounds an error of the inertial navigation over time.

3. The system of claim 1, comprising the data processing system to:
store a map on the memory, the map storing the plurality of values of gravity mapped to the plurality of positions; and
retrieve, based on the estimated position, the value of gravity from the map.

4. The system of claim 1, comprising the data processing system to:
retrieve the value of gravity based on a predicted position of the system.

5. The system of claim 1, comprising the data processing system to:
execute at least one navigation function that compensates for local gravity at the estimated position of the system with the value of gravity.

6. The system of claim 1, comprising the data processing system to:
execute at least one navigation function that compensates for local gravity at the estimated position of the system through a subtraction with the value of gravity; and
determine an error in the position based on the altitude error, wherein the altitude error indicates an error in the subtraction caused by the error in the position.

7. The system of claim 1, comprising the data processing system to:
retrieve the reference altitude from the memory, wherein the reference altitude is a predetermined level stored by the memory; and
compare the altitude with the reference altitude responsive to a retrieval of the reference altitude from the memory.

8. The system of claim 1, comprising the data processing system to:
retrieve the reference altitude from the memory, wherein the reference altitude is a predetermined sea level of a ship stored by the memory; and
compare the altitude with the reference altitude responsive to a retrieval of the reference altitude from the memory.

9. The system of claim 1, comprising the data processing system to:
receive a measurement of pressure from a pressure sensor of a vehicle; and
determine the reference altitude based on the measurement of pressure.

10. The system of claim 1, comprising the data processing system to:
receive a measurement from an altitude sensor; and
determine the reference altitude based on the measurement of the altitude sensor.

11. The system of claim 1, comprising the data processing system to:
receive an angular velocity from a gyroscope;
determine the estimated position based on a specific force of the accelerometer and the angular velocity; and
retrieve the value of gravity from the plurality of values of gravity mapped responsive to a determination of the estimated position.

12. The system of claim 1, comprising the data processing system to:
execute a filter or factor graph to output the position based at least in part on the altitude error.

13. The system of claim 1, comprising the data processing system to:
use the value of gravity that represents a local gravity in an acceleration integration;
retrieve a first gravity partial derivative with respect to a north position from a first plurality of values mapped to the plurality of positions;
retrieve a second gravity partial derivative with respect to an east position from a second plurality of values mapped to the plurality of positions; and
use the first gravity partial derivative and the second gravity partial derivative in propagation of an error state of a filter.

14. A method, comprising:
identifying, by a data processing system, coupled with memory, based on an estimated position of the data processing system, a value of gravity from a plurality of values of gravity mapped to a plurality of positions;
determining, by the data processing system, an altitude of the data processing system based on at least the value of gravity and a force measured by an accelerometer of the data processing system;
comparing, by the data processing system, the altitude with a reference altitude to identify an altitude error; and
determining, by the data processing system, a position of the data processing system based on the altitude error.

15. The method of claim 14, comprising:
performing, by the data processing system, inertial navigation to determine positions of the data processing system over time with the altitude error, wherein the inertial navigation with the altitude error bounds an error of the inertial navigation over time.

16. The method of claim 14, comprising:
executing, by the data processing system, at least one navigation function that compensates for local gravity at the estimated position of the data processing system through a subtraction with the value of gravity; and
determining, by the data processing system, an error in the position based on the altitude error.

17. An inertial navigation system, comprising:
an accelerometer to measure a force;
a gyroscope to measure a rotational velocity; and
processing circuitry to:
retrieve, based on an estimated position of a platform including the inertial navigation system, a value of gravity from a plurality of values of gravity mapped to a plurality of positions;
determine an altitude of the platform based on at least the value of gravity, the force, and the rotational velocity;
compare the altitude with a reference altitude to determine an altitude error; and
determine a position of the platform based on the altitude error.

18. The inertial navigation system of claim 17, comprising the processing circuitry to:
perform inertial navigation to determine positions of the platform over time with the altitude error, wherein the inertial navigation with the altitude error bounds an error of the inertial navigation over time.

19. The inertial navigation system of claim 17, comprising the processing circuitry to:
execute at least one navigation function that compensates for local gravity at the estimated position of the platform through a subtraction with the value of gravity; and
determine an error in the position based on the altitude error, wherein the altitude error indicates an error in the subtraction caused by the error in the position.

20. The inertial navigation system of claim 17, comprising:
a gravimeter to measure a second force; and
the processing circuitry to compensate for a factor of the accelerometer with the second force measured by the gravimeter.
